(19) United States
(12) Patent Application Publication
(10) Pub. No.: US 2022/0281208 A1
(43) Pub. Date: Sep. 8, 2022

(54) LAMINATED FABRIC STRUCTURE AND METHOD FOR FABRICATING THE SAME

(71) Applicant: Nano and Advanced Materials Institute Limited, Hong Kong (CN)

(72) Inventors: Yu Hang LEUNG, Hong Kong (CN); Ho Wang TONG, Hong Kong (CN); Chi Hang YU, Hong Kong (CN); Ting YANG, Hong Kong (CN)

(21) Appl. No.: 17/452,263

(22) Filed: Oct. 26, 2021

Related U.S. Application Data
(60) Provisional application No. 63/200,330, filed on Mar. 2, 2021.

(51) Int. Cl. B32B 7/14; B32B 5/02; B32B 5/26; B32B 37/12

(52) U.S. Cl. CPC B32B 7/14; B32B 5/022; B32B 5/024; B32B 5/262; B32B 5/265; B32B 37/12; B32B 2262/02; B32B 2437/00

(57) ABSTRACT

The present disclosure provides a laminated fabric structure comprising: a fabric layer; a nanofibrous membrane comprising a matrix of nanofibers; and a permeable adhesive layer sandwiched between the fabric layer and the nanofibrous membrane and comprising a filled portion and an unfilled portion. The permeable adhesive layer is able to combine the nanofibrous membrane and fabric layers together to provide significant protection on the nanofibrous membrane without sacrificing on the air permeability of the laminated fabric structure.

### CROSS-REFERENCE TO RELATED APPLICATIONS

This application claims the benefit of U.S. Provisional Patent Application No. 63/200,330, filed on Mar. 2, 2021, which is incorporated by reference herein in its entirety.

### TECHNICAL FIELD

The present disclosure relates to a laminated fabric structure and a method for fabricating the same.

### BACKGROUND

The recent COVID-19 pandemic alters the view of wearing face masks and makes face mask a daily accessory worldwide. The most commonly found face masks in the market are made of polypropylene (PP) spunbond and meltblown nonwovens. These face masks are intended for one-time use thereby generating a lot of environmental issues. The filtering layer of most face masks is made of PP meltblown which uses static charge as the major mean of filtration. When it is subjected to water vapor or is wetted, the static charge will dissipate and the filtration performance will be detrimentally affected. It is the main reason why PP meltblown cannot be used as the filtering layer on washable face masks.

Recently, there are face masks made of fabrics emerging in the market. These fabric face masks can be cleaned by washing and reused for a number of times. These face masks also allow customized patterns and styles which turn them into fashionable items. However, most of these fabric face masks have limited protection against airborne aerosol which is the major means of infection. Additional filter layers are introduced as inserts to enhance the protection. Similar to surgical face masks, these filters are often made of polypropylene spunbond and meltblown which have to be disposed after use.

On the other hand, nanofibers do not have the aforesaid problems since static charge does not play a major role on the filtering performance. It has been suggested that it is favorable to use nanofibers in face masks for sports use. The major drawback is that it is prone to mechanical damages. In particular, if the nanofibrous membrane is very thin in a form of coating, it can be damaged easily by stretching or rubbing. Such weakness limits the use of nanofibers to the disposable or one-time use applications.

A need therefore exists for a washable face mask that eliminates or at least diminishes the disadvantages and problems described above.

### SUMMARY

Provided herein is a laminated fabric structure comprising: a first fabric layer; a nanofibrous membrane comprising a matrix of nanofibers and having a first surface and a second surface being opposite to the first surface; a first permeable adhesive layer sandwiched between the first fabric layer and the first surface and comprising a first filled portion and a first unfilled portion, the first filled portion being arranged in a first pattern and connecting the first fabric layer and the nanofibrous membrane together, the first unfilled portion allowing air to pass through; a second fabric layer; and a second permeable adhesive layer sandwiched between the second fabric layer and the second surface and comprising a second filled portion and a second unfilled portion, the second filled portion being arranged in a second pattern and connecting the second fabric layer and the nanofibrous membrane together, the second unfilled portion allowing air to pass through.

In certain embodiments, the first filled portion comprises a plurality of first adhesive columns separated by the first unfilled portion; and the second filled portion comprises a plurality of second adhesive columns separated by the second unfilled portion.

In certain embodiments, the first unfilled portion comprises a plurality of first holes separated by the first filled portion; and the second unfilled portion comprises a plurality of second holes separated by the second filled portion.

In certain embodiments, the first filled portion comprises a plurality of first adhesive columns separated by the first unfilled portion; and the second unfilled portion comprises a plurality of second holes separated by the second filled portion.

In certain embodiments, the first unfilled portion cover 15% to 25% of the first surface; and the second unfilled portion cover 15% to 25% of the second surface.

In certain embodiments, each first adhesive column has a cross-sectional area between 1 mm² and 0.1 mm² and is separated from a respective first adhesive column with a distance between 0.3 mm and 0.7 mm; and each second adhesive column has a cross-sectional area between 1 mm² and 0.1 mm² and is separated from a respective second adhesive column with a distance between 0.3 mm and 0.7 mm.

In certain embodiments, each first adhesive column has a cross section being circular, oval, square, rectangular or triangular; and each second adhesive column has a cross section being circular, oval, square, rectangular or triangular.

In certain embodiments, each of the first filled portion and the second filled portion comprises a polyurethane reactive adhesive or a hot melt adhesive.

In certain embodiments, the nanofibers are electrospun nanofibers.

In certain embodiments, each nanofiber comprises polyvinylidene fluoride, polyurethane, as polyvinylchloride (PVC), poly(lactic acid) (PLA), poly(ε-caprolactone) (PCL) or poly(lactic-co-glycolic acid) (PLGA), and has a diameter between 50 nm and 200 nm.

In certain embodiments, the nanofibrous membrane has a thickness between 0.5 μm and 3 μm.

In certain embodiments, each of the first fabric layer and the second fabric layer comprises a woven fabric or a nonwoven fabric.

In certain embodiments, each of the first fabric layer and the second fabric layer comprises cotton, nylon or polyester.

Provided herein is an air filtering fabric comprising the laminated fabric structure described above.

Provided herein is a washable face mask comprising the laminated fabric structure described above.

Provided herein is a method for fabricating the laminated fabric structure described above comprising: providing the nanofibrous membrane; printing a first adhesive on the first fabric layer under a first pattern used for forming the first permeable adhesive layer; sandwiching the printed first adhesive between the first fabric layer and the first surface of the nanofibrous membrane; solidifying the printed first adhesive sandwiched between the first fabric layer and the first surface of the nanofibrous membrane thereby forming the first permeable adhesive layer; printing a second adhesive on the second fabric layer under a second pattern used for forming the second permeable adhesive layer; sandwiching the printed second adhesive between the second fabric layer and the second surface of the nanofibrous membrane; and solidifying the printed second adhesive sandwiched between the second fabric layer and the second surface of the nanofibrous membrane thereby forming the second permeable adhesive layer such that the laminated fabric structure is formed.

In certain embodiments, the first adhesive is printed on the first layer by a first gravure roller; and the second adhesive is printed on the second layer by a second gravure roller.

In certain embodiments, each of the first adhesive and the second adhesive is a hot melt adhesive or a polyurethane reactive adhesive.

In certain embodiments, the step of providing the nanofibrous membrane comprises depositing the nanofibers onto a collecting substrate thereby forming the nanofibrous memebrane.

Provided herein is a laminated fabric structure comprising: a fabric layer; a nanofibrous membrane comprising a matrix of nanofibers; and a permeable adhesive layer sandwiched between the fabric layer and the nanofibrous membrane and comprising a filled portion and an unfilled portion, the filled portion being arrange in a pattern and connecting the fabric layer and the nanofibrous membrane together, the unfilled portion allowing air to pass through; wherein the filled portion comprises a plurality of adhesive columns separated by the unfilled portion; or the unfilled portion comprises a plurality of holes separated by the filled portion.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Other aspects of the present invention are disclosed as illustrated by the embodiments hereinafter.

### BRIEF DESCRIPTION OF DRAWINGS

The appended drawings, where like reference numerals refer to identical or functionally similar elements, contain figures of certain embodiments to further illustrate and clarify the above and other aspects, advantages and features of the present invention. It will be appreciated that these drawings depict embodiments of the invention and are not intended to limit its scope. The invention will be described and explained with additional specificity and detail through the use of the accompanying drawings in which:

FIG. 1 is a schematic diagram depicting a cross section of a laminated fabric structure according to certain embodiments;

FIG. 2 is a schematic diagram depicting a cross section of a laminated fabric structure according to certain embodiments;

FIG. 3 is a schematic diagram depicting an air filtering fabric having a laminated fabric structure according to certain embodiments;

FIG. 4A is a schematic diagram depicting a pattern of a permeable adhesive layer according to certain embodiments;

FIG. 4B is a schematic diagram depicting another pattern of a permeable adhesive layer according to certain embodiments.

FIG. 5 is a flow chart depicting a method for fabricating a laminated fabric structure according to certain embodiments;

FIG. 6 is a schematic diagram depicting a method for fabricating a laminated fabric structure according to certain embodiments;

FIG. 7 is a schematic diagram depicting a system for fabricating a laminated fabric structure according to certain embodiments;

FIG. 8A is a scanning electron microscope (SEM) image of a matrix of electrospun nanofibers of a nanofibrous membrane;

FIG. 8B is a SEM image of the matrix of electrospun nanofibers with higher magnification;

FIG. 9 shows the fractional filtration efficiencies of an air filtering fabric under different particle sizes after different handwashing cycles, and an inset shows the normalized pressure drop of the air filtering fabric after 20 handwashing cycles; and

FIG. 10 shows the fractional filtration efficiencies of air filtering fabrics having different thicknesses under different particle sizes.

Skilled artisans will appreciate that elements in the figures are illustrated for simplicity and clarity and have not necessarily been depicted to scale.

### DETAILED DESCRIPTION OF THE INVENTION

As used herein in the specification and appended claims, the term “fabric layer” refers to a fabric layer being permeable to air.

The present disclosure provides a laminated fabric structure and a method for fabricating the laminated fabric structure.

Certain embodiments of the present disclosure provide a laminated fabric structure comprising: a fabric layer; a nanofibrous membrane comprising a matrix of nanofibers; and a permeable adhesive layer sandwiched between the fabric layer and the nanofibrous membrane and comprising a filled portion and an unfilled portion, the filled portion being arranged in a first pattern and connecting the fabric layer and the nanofibrous membrane together, the unfilled portion allowing air to pass through; wherein the filled portion comprises a plurality of adhesive columns separated by the unfilled portion, or the unfilled portion comprises a plurality of holes separated by the filled portion.

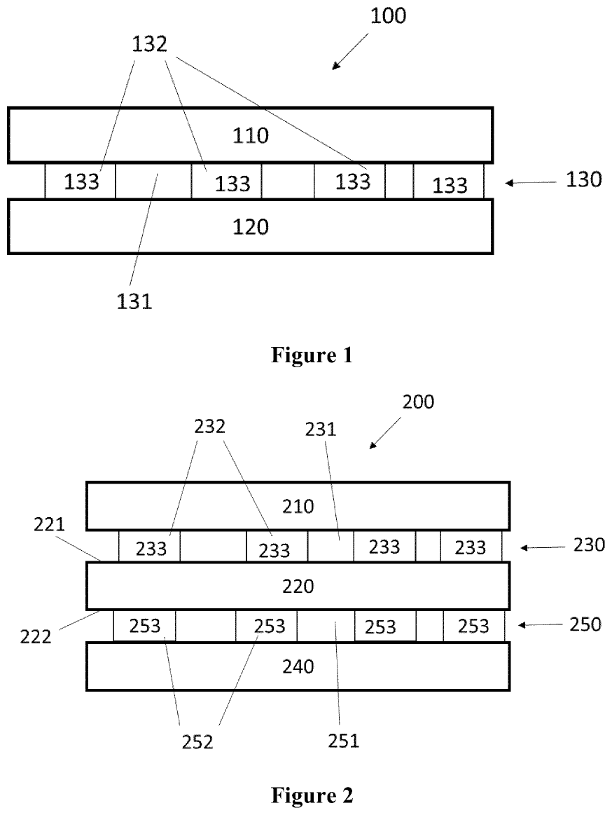

FIG. 1 is a schematic diagram depicting a laminated fabric structure 100 according to certain embodiments. The laminated fabric structure 100 comprises a fabric layer 110, a nanofibrous membrane 120 and a permeable adhesive layer 130 sandwiched between the fabric layer 110 and the nanofibrous membrane 120. The fabric layer 110 acts as a protective layer for protecting the nanofibrous membrane 120. The nanofibrous membrane 120 comprises a matrix of electrospun nanofibers for filtering airborne contaminants (e.g., virus, bacteria, particles, dust, pollen, pollutants, etc). The permeable adhesive layer 130 consists of an unfilled portion 131 and a filled portion 132 including a plurality of adhesive columns 133 separated by the unfilled portion 131. The unfilled portion 131 allows air to pass through. The plurality of adhesive columns 133 connects the fabric layer 120 and the nanofibrous membrane 110 together. The permeable adhesive layer 130 is able to tightly combine the fiber layer 110 and the nanofibrous membrane 120 together in view of the filled portion 132, which is the plurality of adhesive columns 133 in this embodiment, for providing mechanical protection to the nanofibrous membrane 120. In the meantime, the permeable adhesive layer 130 provides good air permeability of the laminated fabric structure in view of the unfilled portion 131.

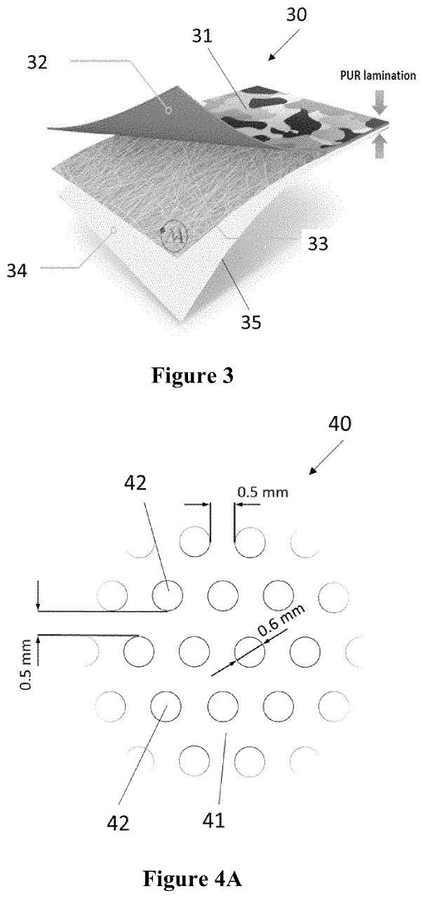

FIG. 2 is a schematic diagram depicting a laminated fabric structure 200 according to certain embodiments. The laminated fabric structure 200 comprises a first fabric layer 210, a nanofibrous membrane 220 and a first permeable adhesive layer 230, a second fabric layer 240 and a second permeable adhesive layer 250. The first fabric layer 210 and the second fabric layer 240 act as protective layers for protecting the nanofibrous membrane 220. The first permeable adhesive layer 230 is sandwiched between the first fabric layer 210 and a first surface 221 of the nanofibrous membrane 220. The nanofibrous membrane 210 comprises a matrix of electrospun nanofibers for filtering airborne contaminants. The first permeable adhesive layer 230 consists of a first unfilled portion 231 and a first filled portion 232 including a plurality of first adhesive columns 233 separated by the first unfilled portion 231. The first unfilled portion 231 allows air to pass through. The first filled portion 232 connects the first fabric layer 220 and the nanofibrous membrane 210 together. The second permeable adhesive layer 250 is sandwiched between the second fabric layer 210 and a second surface 222 of the nanofibrous membrane 220. The second permeable adhesive layer 250 consists of a second unfilled portion 251 and a second filled portion 252 including a plurality of second adhesive columns 253 separated by the second unfilled portion 251. The first unfilled portion 251 allows air to pass through. The second filled portion 232 connects the second fabric layer 240 and the nanofibrous membrane 220 together.

In certain embodiments, the unfilled portion covers 15% to 25% of the surface of the fibrous membrane. In certain embodiments, the hole of the unfilled portion is circular, oval, square, rectangular, triangular or any other shapes. The hole has a diameter, width or length in the range of 0.5 to 0.7 mm.

In certain embodiments, each adhesive column has a cross-sectional area between 0.5 mm² and 0.1 mm². In certain embodiments, each adhesive column is separated from a respective adhesive column with a distance between 0.3 mm and 0.7 mm. In certain embodiments, each adhesive column has a cross section being circular, oval, square, rectangular, triangular or any other shapes.

In certain embodiments, the filled portion comprises a polyurethane reactive adhesive or a hot melt adhesive.

In certain embodiments, the electrospun nanofiber comprises polyvinylidene fluoride, polyurethane, as polyvinylchloride (PVC), poly(lactic acid) (PLA), poly(ε-caprolactone) (PCL) or poly(lactic-co-glycolic acid) (PLGA). In certain embodiments, the electrospun nanofiber has a diameter between 50 nm and 200 nm. In certain embodiments, the nanofibrous membrane has a thickness between 0.5 μm and 3 μm, or between 1 μm and 2 μm.

In certain embodiments, the fabric layer comprises a woven fabric or a nonwoven fabric.

In certain embodiments, the fabric layer comprises cotton, nylon or polyester.

In certain embodiments, the fabric layer has a thickness between 200 μm and 400 μm.

In certain embodiments, the fabric layer has a weight per unit area between 75 and 150 gram per square meter. In certain embodiments, the fabric layer has an air permeability above 200 cm³/cm²/s at 125 Pa.

In certain embodiments, the fibrous membrane is combined with the fabric layer by polyurethane reactive (PUR) lamination or hot melt adhesive lamination.

In certain embodiments, the laminated fabric structure has a weight per unit area between 150 and 300 gram per square meter. In certain embodiments, the laminated fabric structure has a thickness between 600 μm and 800 μm.

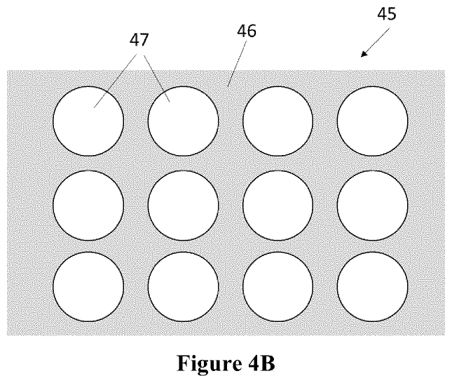

FIG. 3 is a schematic diagram depicting an air filtering fabric (or a face mask, e.g., a washable face mask) 300 having a laminated fabric structure according to certain embodiments. The air filtering fabric 300 includes a first fabric layer 310, a first permeable adhesive layer 320, a fibrous membrane 330, a second permeable adhesive layer 340 and a second fabric layer 350, which are stacked and connected together by polyurethane reactive lamination.

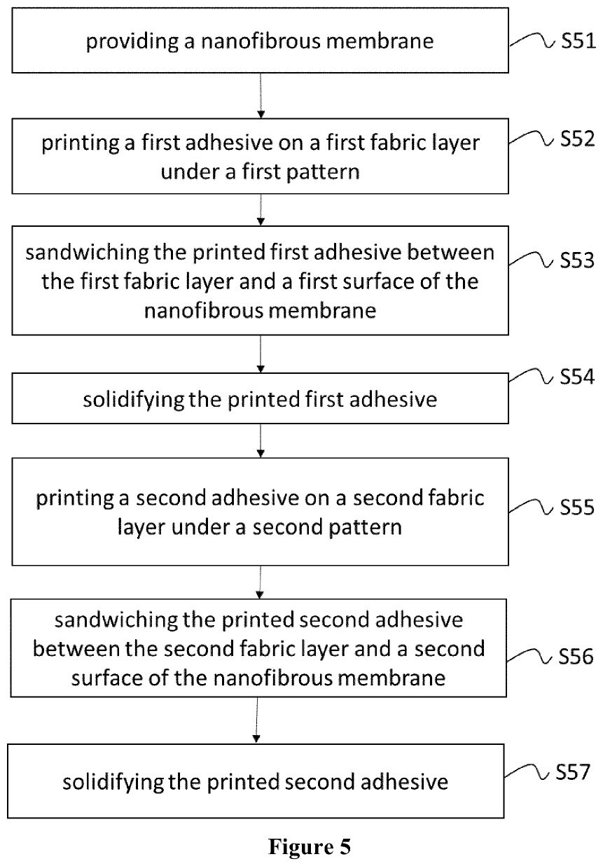

FIG. 4A is a schematic diagram depicting a pattern of a permeable adhesive layer according to certain embodiments. The permeable adhesive layer 40 comprise an unfilled portion 41 and a plurality of adhesive columns 42 separated by the unfilled portion 41. The plurality of adhesive columns 42 is evenly distributed and arranged in rows. The cross section of the adhesive columns 42 is circular and has a diameter of 0.6 mm. The adhesive columns 42 in each row are separated with 0.5 mm and the rows are separated with 0.5 mm.

In certain embodiments, the unfilled portion is in a grid pattern and the adhesive columns are in square or rectangular shape.

FIG. 4B is a schematic diagram depicting another pattern of a permeable adhesive layer according to certain embodiments. The permeable adhesive layer 45 comprise a filled portion 46 and a plurality of circular holes 47 separated by the filled portion 46.

In certain embodiments, the filled portion is in a grid pattern and the holes are in square or rectangular shape.

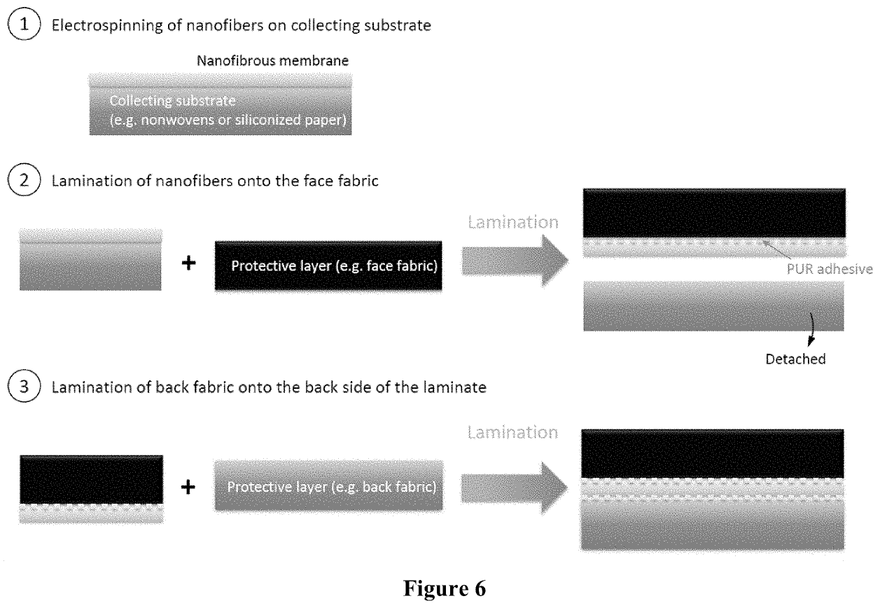

FIG. 5 is a flow chart depicting a method for fabricating a laminated fabric structure according to certain embodiments. In step S51, a nanofibrous membrane is provided. In step S52, a first adhesive is printed on a first fabric layer under a first pattern used for forming a first permeable adhesive layer. In step S53, the printed first adhesive is sandwiched between the first fabric layer and a first surface of the nanofibrous membrane. In step S54, the printed first adhesive is solidified thereby forming the first permeable adhesive layer. In step S55, a second adhesive is printed on a second fabric layer under a second pattern used for forming a second permeable adhesive layer. In step S56, the printed second adhesive is sandwiched between the second fabric layer and a second surface of the nanofibrous membrane. In step S57, the printed second adhesive is solidified thereby forming the second permeable adhesive layer so that the laminated fabric structure is formed.

In certain embodiments, the adhesive is printed on the fabric layer by a gravure lamination. The gravure lamination includes a gravure roller having a plurality of cells on its surface with gravure/pattern. With the gravure lamination, adhesive is applied as a pattern or a grid on the surface of the fabric layer (or the fibrous membrane), thereby leaving holes/voids/space within the adhesive layer as formed thereby providing the permeable adhesive layer being able to combine the nanofibrous membrane and fabric layers together to provide significant protection on the nanofibrous membrane without sacrificing on the air permeability of the laminated fabric structure.

As the major component for filtration function in the air filtering fabric is the membrane made of nanofibers. Nanofibers are prone to mechanical damage. After lamination, the nanofibers are embedded within the protective layers. The resultant laminate can then resist the mechanical stress during washing.

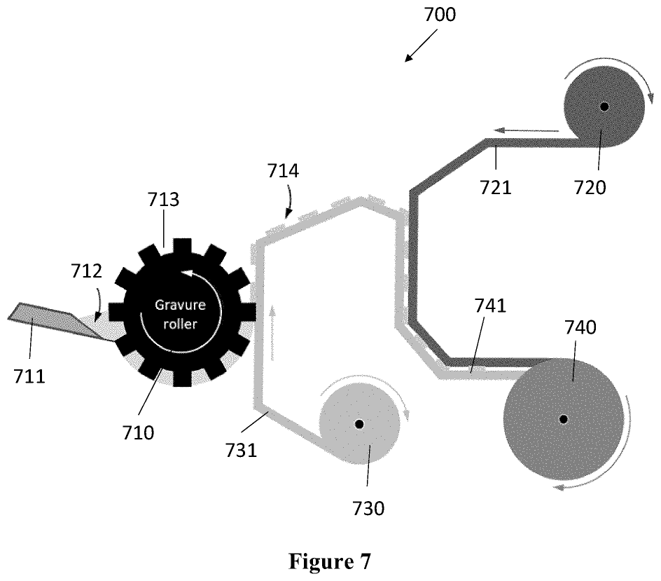

FIG. 6 is a schematic diagram depicting a method for fabricating a laminated fabric structure according to certain embodiments. In step 1, nanofibers are deposited on a collecting substrate (e.g., nonwovens or siliconized paper) by electrospinning to form a nanofibrous membrane. The collecting substrate can be made of PP spunbond, polyethylene terephthalate (PET) spunbond, or a siliconized paper. In step 2, the nanofibrous membrane is laminated onto a protective layer (e.g., a face fabric) with a PUR adhesive patterned and partially covered on the protective layer so that a laminate is formed. Then, the collecting substrate is detached from the nanofibrous membrane. In step 3, a protective layer (e.g., back fabric) is laminated onto a back side of the laminate (i.e., the nanofibrous membrane) with a polyurethane reactive (PUR) adhesive patterned and partially covered on the protective layer so that the laminated fabric structure is formed.

In certain embodiments, PUR adhesives have one-part formulations that combine the initial speed of a hot melt adhesive with the strength of a structural adhesive. The bond forms in two stages: when the adhesive cools back down and solidifies like a hot melt it reaches holding strength, then the moisture-curing reaction proceeds over the next 24-48 hours to reach final structural strength. The PUR adhesive used has viscosity of 6000-10000 mPa·s at 120° C.

Comparing to hot melt adhesive, PUR adhesives are resistant to temperature extremes. They creates much stronger and longer lasting bond. Also, PUR adhesives have higher water and chemical resistance, which lead to higher washability.

In certain embodiments, hot melt adhesive mesh is used, which is sandwiched between the fabrics and melted using hot press.

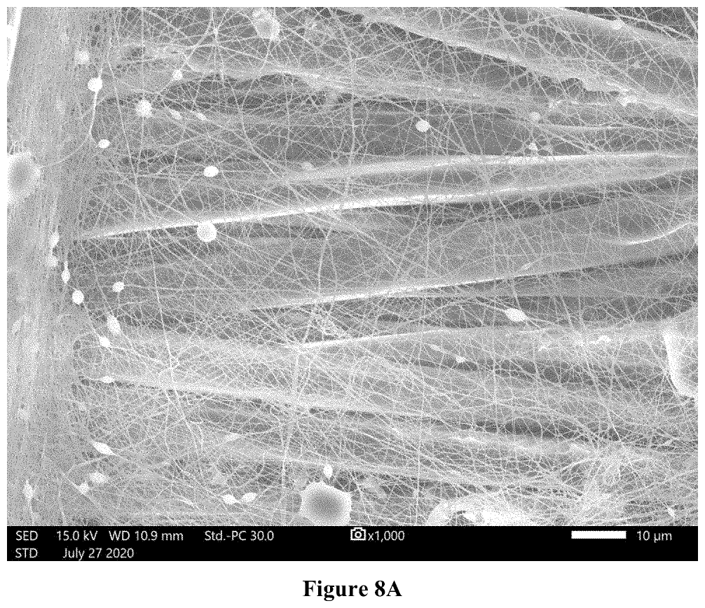

FIG. 7 is a schematic diagram depicting a fabrication system 700 for fabricating a laminated fabric structure according to certain embodiment. The fabrication system 700 comprises a gravure roller 710, a doctor blade 711, a molten adhesive 712, a roll A 720, a roll B 730 and a roll C 740. The gravure roller 710 comprises a plurality of cells 713 on its surface in pattern. The roll A 720 comprises a fibrous membrane 721. The roll B 730 comprises a fabric layer 731. The doctor blade 711 fills the cells 713 with the molten adhesive 712. The roll B 730 is rotated to feed out the fabric layer 731. The gravure roller 710 is rotated to print the molten adhesive 712 on the fabric layer 731 to form the printed adhesive 714 in a pattern on the fabric layer 731. The roll A 720 is rotated to feed out the nanofibrous membrane 721 such that the printed adhesive 714 is sandwiched and solidified between the fabric layer 731 and the nanofibrous membrane 721 to form a laminate 741, which is rolled into roll C 740.

In certain embodiments, the gravure roller has pattern (cell) depth of about 0.7 mm. The pattern depth determines the amount of adhesive being applied. The linear speed of lamination is in the range of 2-4 m/min.

### Example 1

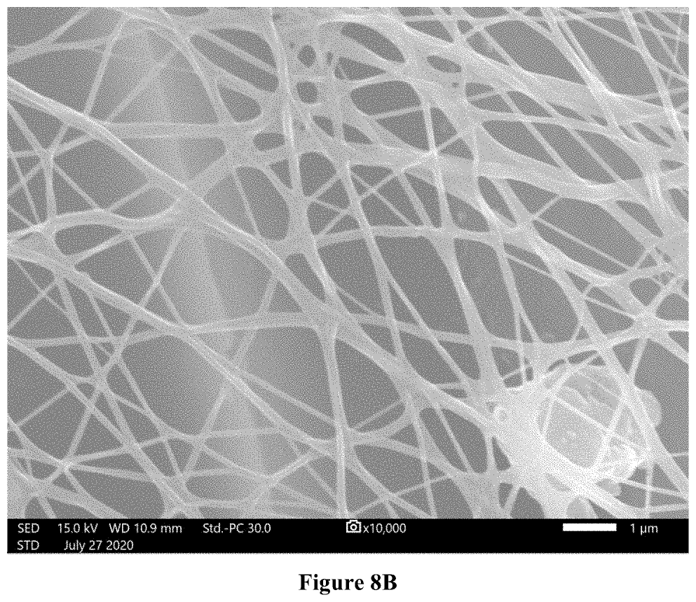

FIGS. 8A and 8B show SEM images of the matrix of electrospun nanofibers of a fibrous membrane. The nanofibers were made with Poly(vinylidene fluoride-co-hexafluoropropylene) (PVDF-HFP). They are fabricated using Elmarco® NS 1S500U electrospinning system. Firstly, a polymer solution made of 15-20% w/v poly(vinylidene fluoride-co-hexafluoropropylene) (PVDF-HFP) and 0.1-0.5% w/v benzyltriethylammonium chloride (BTEAC) was prepared in dimethylformamide (DMF). Then, the resultant polymer solution was loaded into the electrospinning system for electrospinning. The electrospinning process parameters were as follows: accelerating voltage: 70-100 kV; distance between the spinning and collecting electrodes (i.e. working distance): 160-200 mm; substrate speed: 0.4-0.8 m/min; spinning chamber relative humidity: 20-40%; and spinning chamber temperature: 22-25 degree Celsius. As shown in the images, the nanofibers have a diameter between 50 nm and 200 nm.

### Example 2

A particle filtration test was conducted with an air filtering fabric having the laminated fabric structure described above under different handwashing cycles. A nanofibrous membrane was firstly prepared on polypropylene spunbond (PPSB) substrates with antistatic treatment using the parameters of Example 1. The accelerating voltage, working distance, substrate speed, spinning chamber relatively humidity, and spinning chamber temperature were 100 kV, 160 mm, 0.7 m/min, 25% and 23 degree Celsius, respectively. The substrate had sheet resistance of 107-109 ohm/sq. The nanofibrous membrane was then transferred and attached to the backside of the face fabric made with nylon using PUR lamination. The speed of lamination was 2 m/min. The PPSB substrate was detached from the nanofibrous membrane during the process. Then, the back fabric made of polyester was then attached to the nanofibrous membrane side of the assembly using PUR lamination to form the complete laminate. Both face fabric and back fabric have air permeability of >200 cm³/cm²/s at 125 Pa.

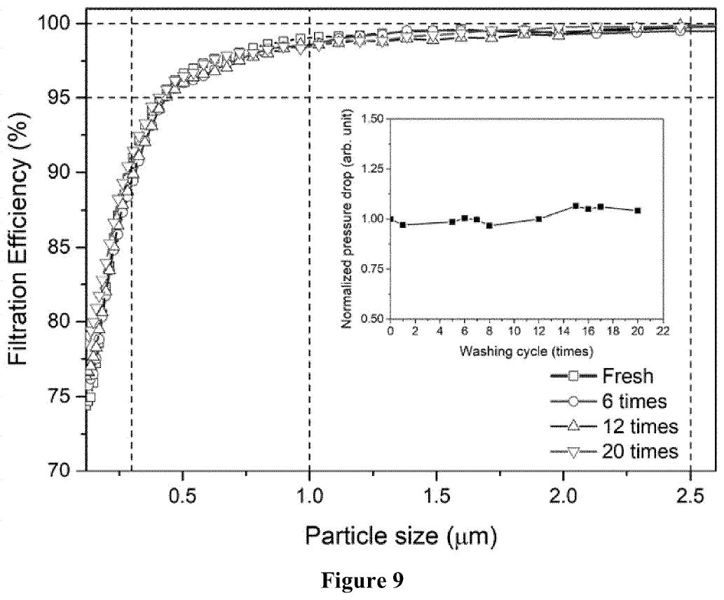

As shown in FIG. 9, it is close to no drop in filtration efficiency of the air filtering fabric after 20 handwashing cycles. After 20 handwashing cycles, the air filtering fabric provides filtration efficiencies with 99%, 98% and 91% at particle sizes of 2.5 μm, 1.0 μm and 0.3 μm respectively. In addition, the pressure drop of the air filtering fabric remains substantially the same after 20 handwashing cycles. Thus, the air filtering fabric can withstand 20 handwashing cycles without significant detrimental effects observed on neither the filtration performance nor pressure drop.

### Example 3

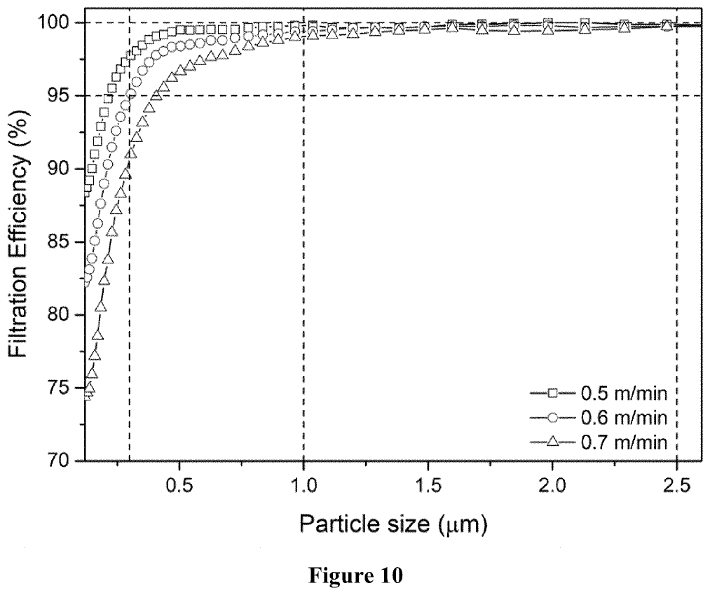

A particle filtration test was conducted with air filtering fabrics having different nanofibrous membrane thicknesses. The air filtering fabrics were prepared similar to the method of Example 2 except that the thickness of the nanofibrous membranes was controlled by different linear rolling speed of the collecting substrate with 0.5, 0.6 and 0.7 m/min. The filtration efficiencies and the pressure drops of the resultant air filtering fabrics are shown in FIG. 10 and Table 1. When the substrate speed decreases from 0.7 m/min to 0.5 m/min, the filtration efficiency at the particle size of 0.3 μm increases from 91.0% to 97.7% and the pressure drop increase from 132 Pa to 163 Pa, while the filtration efficiency at the particle size of 1 μm and 2.5 μm remains substantially the same.

TABLE 1

| Substrate | Corresponding | Filtration Efficiency (%) at | | | Pressure |
|---|---|---|---|---|---|
| Speed | thickness | particular particle size | | | drop |
| (m/min) | (microns) | 0.3 μm | 1 μm | 2.5 μm | (Pa) |
| 0.5 | 1.1-1.3 | 97.7 | 99.8 | 99.9 | 163 |
| 0.6 | 0.9-1.1 | 95.1 | 99.4 | 99.7 | 145 |
| 0.7 | 0.8-0.9 | 91.0 | 99.1 | 99.7 | 132 |

The face fabrics and bottom fabrics have minimal contribution or effects on the filtration efficiencies of the resultant air filtering fabrics. Meanwhile, the pressure drop can be severely affected by the face fabric/bottom fabrics if they do not meet the air permeability requirement.

Thus, it can be seen that an improved laminated fabric structure and fabrication process for the same have been disclosed which eliminates or at least diminishes the disadvantages and problems associated with prior art air filtering fabric. The nanofibrous membrane of the present laminated fabric structure is well protected against mechanical damages by the fabric layers, hence allowing the use in applications which require durability and long lifetime. The air filtering fabric having the present laminated fabric structure is able to provide high filtration efficiency and withstand washing under many cycles, and no significant detrimental effects are found on neither the filtration efficiency nor pressure drop after washing.

The present laminated fabric structure is applicable to face masks, washable facemasks, air filtering fabrics, personal protection equipment, window curtain, air conditioning filters, or etc.

Although the invention has been described in terms of certain embodiments, other embodiments apparent to those of ordinary skill in the art are also within the scope of this invention. Accordingly, the scope of the invention is intended to be defined only by the claims which follow.

What is claimed is:

1. A laminated fabric structure comprising:
a first fabric layer;
a nanofibrous membrane comprising a matrix of nanofibers and having a first surface and a second surface being opposite to the first surface;
a first permeable adhesive layer sandwiched between the first fabric layer and the first surface and comprising a first filled portion and a first unfilled portion, the first filled portion being arranged in a first pattern and connecting the first fabric layer and the nanofibrous membrane together, the first unfilled portion allowing air to pass through;
a second fabric layer; and
a second permeable adhesive layer sandwiched between the second fabric layer and the second surface and comprising a second filled portion and a second unfilled portion, the second filled portion being arranged in a second pattern and connecting the second fabric layer and the nanofibrous membrane together, the second unfilled portion allowing air to pass through.

2. The laminated fabric structure of claim 1, wherein the first filled portion comprises a plurality of first adhesive columns separated by the first unfilled portion; and the second filled portion comprises a plurality of second adhesive columns separated by the second unfilled portion.

3. The laminated fabric structure of claim 1, wherein the first unfilled portion comprises a plurality of first holes separated by the first filled portion; and the second unfilled portion comprises a plurality of second holes separated by the second filled portion.

4. The laminated fabric structure of claim 1, wherein the first filled portion comprises a plurality of first adhesive columns separated by the first unfilled portion; and the second unfilled portion comprises a plurality of second holes separated by the second filled portion.

5. The laminated fabric structure of claim 1, wherein the first unfilled portion cover 15% to 25% of the first surface; and the second unfilled portion cover 15% to 25% of the second surface.

6. The laminated fabric structure of claim 2, wherein each first adhesive column has a cross-sectional area between 1 mm² and 0.1 mm² and is separated from a respective first adhesive column with a distance between 0.3 mm and 0.7 mm; and each second adhesive column has a cross-sectional area between 1 mm² and 0.1 mm² and is separated from a respective second adhesive column with a distance between 0.3 mm and 0.7 mm.

7. The laminated fabric structure of claim 2, wherein each first adhesive column has a cross section being circular, oval, square, rectangular or triangular; and each second adhesive column has a cross section being circular, oval, square, rectangular or triangular.

8. The laminated fabric structure of claim 1, wherein each of the first filled portion and the second filled portion comprises a polyurethane reactive adhesive or a hot melt adhesive.

9. The laminated fabric structure of claim 1, wherein the nanofibers are electrospun nanofibers.

10. The laminated fabric structure of claim 1, wherein each nanofiber comprises polyvinylidene fluoride, polyurethane, as polyvinylchloride (PVC), poly(lactic acid) (PLA), poly(ε-caprolactone) (PCL) or poly(lactic-co-glycolic acid) (PLGA), and has a diameter between 50 nm and 200 nm.

11. The laminated fabric structure of claim 1, wherein the nanofibrous membrane has a thickness between 0.5 μm and 3 μm.

12. The laminated fabric structure of claim 1, wherein each of the first fabric layer and the second fabric layer comprises a woven fabric or a nonwoven fabric.

13. The laminated fabric structure of claim 1, wherein each of the first fabric layer and the second fabric layer comprises cotton, nylon or polyester.

14. An air filtering fabric comprising the laminated fabric structure of claim 1.

15. A washable face mask comprising the laminated fabric structure of claim 1.

16. A method for fabricating the laminated fabric structure of claim 1 comprising:
providing the nanofibrous membrane;
printing a first adhesive on the first fabric layer under a first pattern used for forming the first permeable adhesive layer;
sandwiching the printed first adhesive between the first fabric layer and the first surface of the nanofibrous membrane;
solidifying the printed first adhesive sandwiched between the first fabric layer and the first surface of the nanofibrous membrane thereby forming the first permeable adhesive layer;
printing a second adhesive on the second fabric layer under a second pattern used for forming the second permeable adhesive layer;
sandwiching the printed second adhesive between the second fabric layer and the second surface of the nanofibrous membrane; and
solidifying the printed second adhesive sandwiched between the second fabric layer and the second surface of the nanofibrous membrane thereby forming the second permeable adhesive layer such that the laminated fabric structure is formed.

17. The method of claim 16, wherein the first adhesive is printed on the first layer by a first gravure roller; and the second adhesive is printed on the second layer by a second gravure roller.

18. The method of claim 16, wherein each of the first adhesive and the second adhesive is a hot melt adhesive or a polyurethane reactive adhesive.

19. The method of claim 16, wherein the step of providing the nanofibrous membrane comprises depositing the nanofibers onto a collecting substrate thereby forming the nanofibrous memebrane.

20. A laminated fabric structure comprising:
a fabric layer;
a nanofibrous membrane comprising a matrix of nanofibers; and
a permeable adhesive layer sandwiched between the fabric layer and the nanofibrous membrane and comprising a filled portion and an unfilled portion, the filled portion being arrange in a pattern and connecting the fabric layer and the nanofibrous membrane together, the unfilled portion allowing air to pass through;
wherein the filled portion comprises a plurality of adhesive columns separated by the unfilled portion; or the unfilled portion comprises a plurality of holes separated by the filled portion.
